(19) United States
(12) Patent Application Publication
(10) Pub. No.: US 2013/0039431 A1
(43) Pub. Date: Feb. 14, 2013

(54) POWER-SCALABLE ENCODING/DECODING APPARATUS AND METHOD

(71) Applicant: Seong-Jun BAE, Daejeon-si (KR)

(72) Inventor: Seong-Jun BAE, Daejeon-si (KR)

(73) Assignee: Electronics and Telecommunications Research Institute, Daejeon (KR)

(21) Appl. No.: 13/572,872

(22) Filed: Aug. 13, 2012

(30) Foreign Application Priority Data
Aug. 12, 2011 (KR) 10-2011-0080819
Aug. 9, 2012 (KR) 10-2012-0087346

(51) Int. Cl. G06F 1/26

(52) U.S. Cl. 375/240.26; 375/E07.168

(57) ABSTRACT

A power-scalable encoding/decoding apparatus and method. The method enables a media encoder/decoder to control, in real time, the power necessary for encoding or decoding process. Accordingly, a user or a system can choose the level of power consumption in accordance with the use environment of the encoder/decoder or the need of applications.

### CROSS-REFERENCE TO RELATED APPLICATION

This application claims the benefit under 35 U.S.C. §119(a) of Korean Patent Applications Nos. 10-2011-0080819, filed on Aug. 12, 2011, 10-2012-0087346, filed on 9 Aug. 2012, the entire disclosures of which are incorporated herein by references for all purposes.

### BACKGROUND

1. Field

The following description relates to a media encoder/decoder, and more particularly, to a media encoding/decoding apparatus capable of controlling its power.

2. Description of the Related Art

With the generalization of wireless networks and the high performance of small devices, a variety of mobile devices that users can use while they are moving have been introduced.

The mobile devices have different sizes, processing capabilities and battery capacities. Such mobile devices have a limited amount of available power that is not sufficient for use in a situation where users are in motion and thus it is not possible to connect their mobile devices to an alternating current (AC) power. Therefore, various methods and techniques have been utilized to reduce power consumed by mobile devices in motion.

For example, if there is only a small amount of data to be processed by a central processing apparatus of a mobile device, the mobile device may be switched into low-speed mode which lowers its power consumption. In addition, the mobile device may be switched to IDLE mode to reduce power consumption when there is no wireless communication transmission/reception data. Further, brightness of a display of the mobile device is automatically or manually adjusted to reduce its power consumption.

Most existing mobile devices need to encode or decode audio or video, or both, and thus have a software module or a hardware module for audio/video encoding/decoding. However, the conventional media encoder/decoder for encoding/decoding the audio and video data cannot control its power consumption in accordance with the available amount of power.

### SUMMARY

The following description relates to an encoding/decoding apparatus and method for controlling, in real time, power consumed for media encoding/decoding processes according a use environment or an application.

In one general aspect, there is provided a power-scalable encoding/decoding apparatus comprising: an encoding/decoding unit configured to perform one or more operations using a different amount of power; and a power adjustment control unit configured to, in response to a power level selection signal being received from a user, control an amount of power consumption of the encoding/decoding unit.

In another general aspect, there is provided a power-scalable encoding/decoding method comprising: receiving a power level selection signal from a user; and controlling an amount of power consumption of an encoding/decoding unit which performs one or more operations using a different amount of power.

Other features and aspects will be apparent from the following detailed description, the drawings, and the claims.

### BRIEF DESCRIPTION OF THE DRAWINGS

FIG. 1 is a diagram illustrating process of power-scalable encoding/decoding process according to an exemplary embodiment of the present invention.

FIG. 2 is a diagram illustrating a power-scalable encoding/decoding apparatus according to an exemplary embodiment of the present invention.

FIG. 3 is a diagram illustrating a power-scalable encoding/decoding apparatus according to another exemplary embodiment of the present invention.

FIG. 4 is a diagram illustrating a power-scalable encoding/decoding apparatus according to another exemplary embodiment of the present invention.

FIG. 5 is a flowchart illustrating a power-scalable encoding/decoding method according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A method described herein is to provide a number of options for power consumption levels and quality levels of output audio or video to thereby allow a user or a system to select an amount of power consumed by an encoder/decoder for media encoding/decoding in accordance with the use environment of the encoder/decoder or the need of applications.

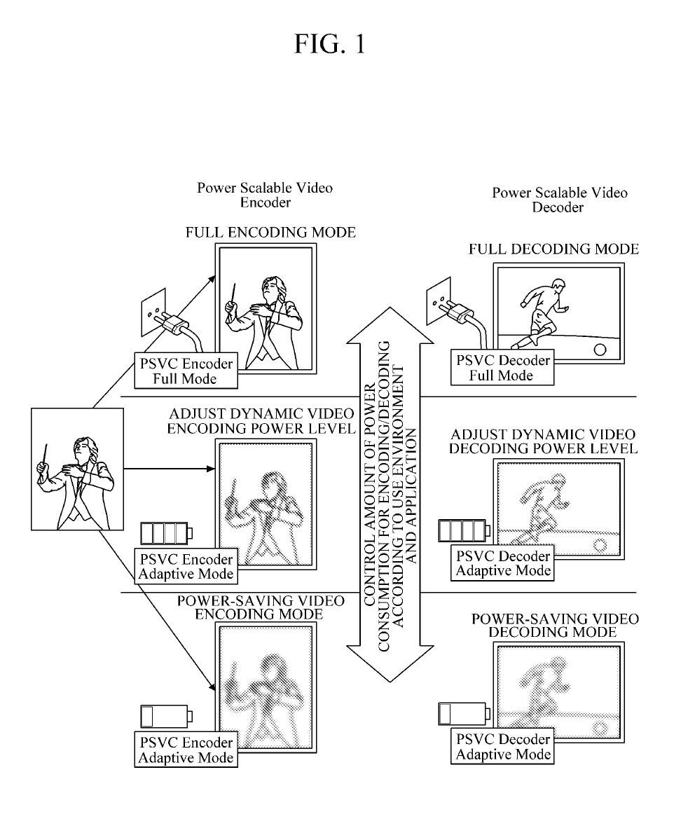

FIG. 1 is a diagram illustrating process of power-scalable encoding/decoding process according to an exemplary embodiment of the present invention.

Referring to FIG. 1, a power-scalable video encoder is illustrated in the left-hand side, and a power-scalable video decoder is illustrated in the right-hand side.

If a mobile device is connected to an alternating current (AC) power and thus sufficient power is available to the video encoder/decoder, the video encoder/decoder inside the device operates in full mode. In this mode, the video encoder/decoder can encode/decode a video with the highest quality.

If the AC power is not available to the mobile device since a user is using the mobile device while moving, the video encoder/decoder may control power consumption for video encoding/decoding in response to a selection signal from a user or a system. When lowering the power consumption, the encoding/decoding quality of video is degraded, but available power time of the device is increased.

When the available power for the mobile device is in short supply, the encoding/decoding quality of video may be minimized so as to extend the available power time.

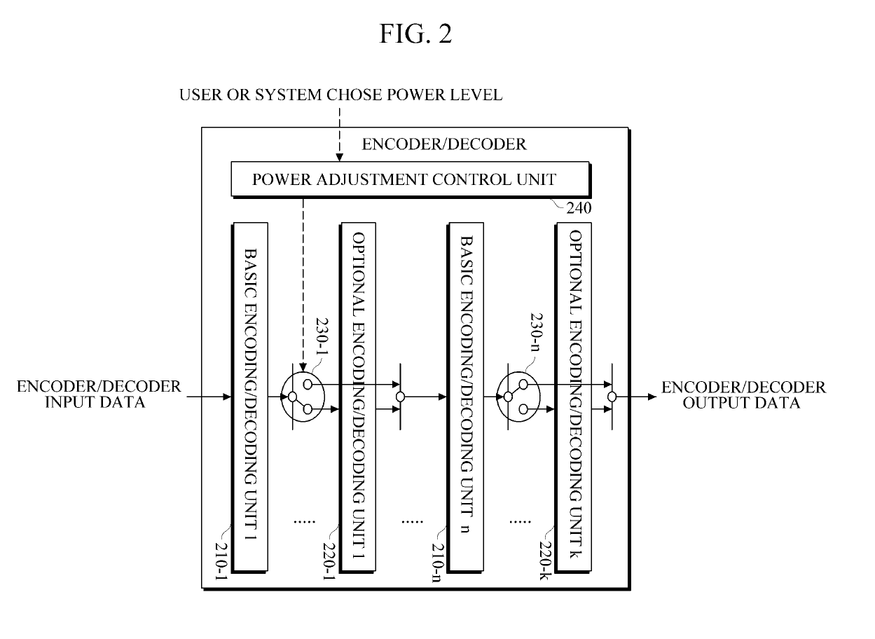

FIG. 2 is a diagram illustrating a power-scalable encoding/decoding apparatus according to an exemplary embodiment of the present invention.

Referring to FIG. 2, the power-scalable encoding/decoding apparatus may include one or more basic encoding/decoding units 210-1, . . . , and 210-n, one or more optional encoding/decoding units 220-1, . . . , and 220-k, one or more switches 230-1, . . . , and 230-n, and a power adjustment control unit 240.

The one or more basic encoding/decoding units 210-1, . . . , and 210-n and the one or more optional encoding/decoding units 220-1, . . . , and 220-k perform intermediate processes to output a signal input from the outside of the apparatus. For example, the basic and optional encoding/decoding units 210-1, . . . , and 210-n and 220-1, . . . , and 220-k may be functional blocks which perform operations involved in encoding/decoding, such as move/copy of memory, motion search, filtering, domain conversion/inversion, arithmetic encoding/decoding and the like. In addition, in the case of encoding/decoding a video having a multi-level frame rate or a multi-level resolution, the basic and optional encoding/decoding units 210-1, . . . , and 210-n and 220-1, . . . , and 220-k may perform quality-related operations to control each level of the frame rate or resolution.

The basic encoding/decoding units 210-1, . . . , and 210-n perform essential procedures for completing encoding/decoding process, and they are connected in series to each other.

The optional encoding/decoding units 220-1, . . . , and 220-k are not necessarily required to complete the overall encoding/decoding process, and perform optional operations. In the example, the optional encoding/decoding units 220-1, . . . , and 220-k are connected in series between the basic encoding/decoding units 210-1, . . . , and 210-n.

Each of the one or more switches 230-1, . . . , and 230-n switches an output signal from one of the basic and optional encoding/decoding units 210-1, . . . , and 210-n and 220-1, . . . , and 220-k to be optionally input to either of one of the optional encoding/decoding units 220-1, . . . , and 220-k or one of the basic encoding/decoding units 210-1, . . . , and 210-n.

The power adjustment control unit 240 determines whether to use each optional encoding/decoding unit 220-1, . . . , and 220-k according to a required amount of power consumption. An external system using the encoder/decoder or the user may manually or automatically choose a preferred power level. In response to the preferred power level being chosen, the power adjustment control unit 240 outputs switching control signals for the one or more switches 230-1, . . . , and 230-n according to the selection of the optional encoding/decoding units 220-1, . . . , and 220-k.

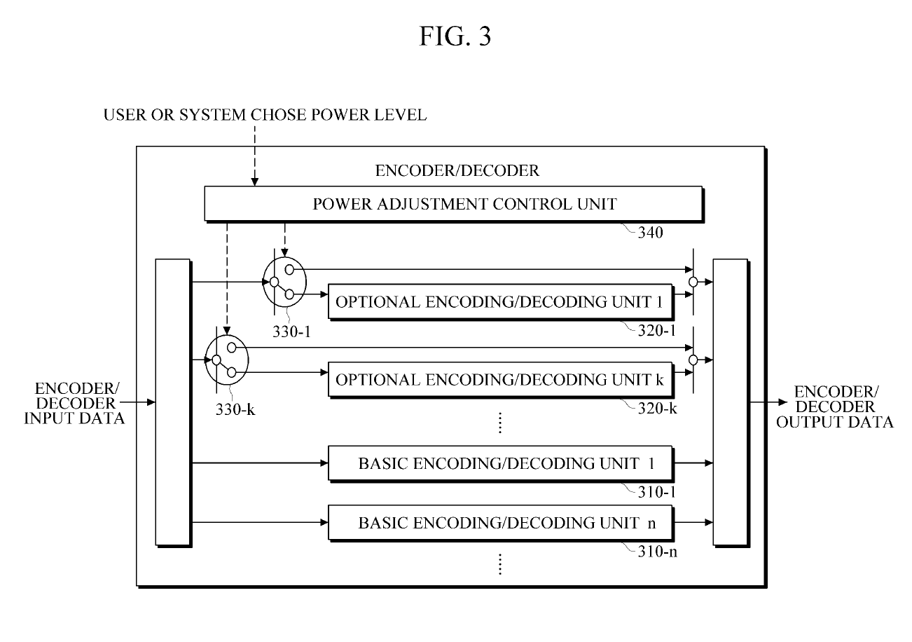

FIG. 3 is a diagram illustrating a power-scalable encoding/decoding apparatus according to another exemplary embodiment of the present invention.

Referring to FIG. 3, the power-scalable encoding/decoding apparatus may include one or more basic encoding/decoding units 310-1, . . . , and 310-n, one or more optional encoding/decoding units 320-1, . . . , and 320-k, one or more switches 330-1, . . . , and 330-k, and a power adjustment control unit 340.

The one or more basic encoding/decoding units 310-1, . . . , and 310-n and the one or more optional encoding/decoding units 320-1, . . . , and 320-k perform intermediate processes to output a signal received from the outside of the apparatus. For example, the basic and optional encoding/decoding units 310-1, . . . , and 310-n and 320-1, . . . , and 320-k may be functional blocks which perform operations involved in encoding/decoding, such as move/copy of memory, motion search, filtering, domain conversion/inversion, arithmetic encoding/decoding and the like. In addition, in the case of encoding/decoding a video having a multi-level frame rate or a multi-level resolution, the basic and optional encoding/decoding units 310-1, . . . , and 310-n and 320-1, . . . , and 320-k may perform quality-related operations to control each level of the frame rate or resolution.

The one or more basic encoding/decoding units 310-1, . . . , and 310-n perform essential procedures for completing encoding/decoding process, and they are connected in parallel to each other.

The optional encoding/decoding units 220-1, . . . , and 220-k are not necessarily required to complete the overall encoding/decoding process, and perform optional operations. In the example, the optional encoding/decoding units 220-1, . . . , and 220-k are connected in parallel to each other.

Each of the one or more switches 330-1, . . . , and 330-k selects each of the one or more optional encoding/decoding units 320-1, . . . and 320-k.

The power adjustment control unit 340 determines whether to use each optional encoding/decoding unit 220-1, . . . , and 220-k according to a required amount of power consumption. An external system using an encoder/decoder or the user may manually or automatically select a preferred power level. In response to the preferred power level being chosen, the power adjustment control unit 340 outputs switching control signals for the one or more switches 330-1, . . . , and 330-k according to the selection of the optional encoding/decoding units 320-1, . . . , and 320-k.

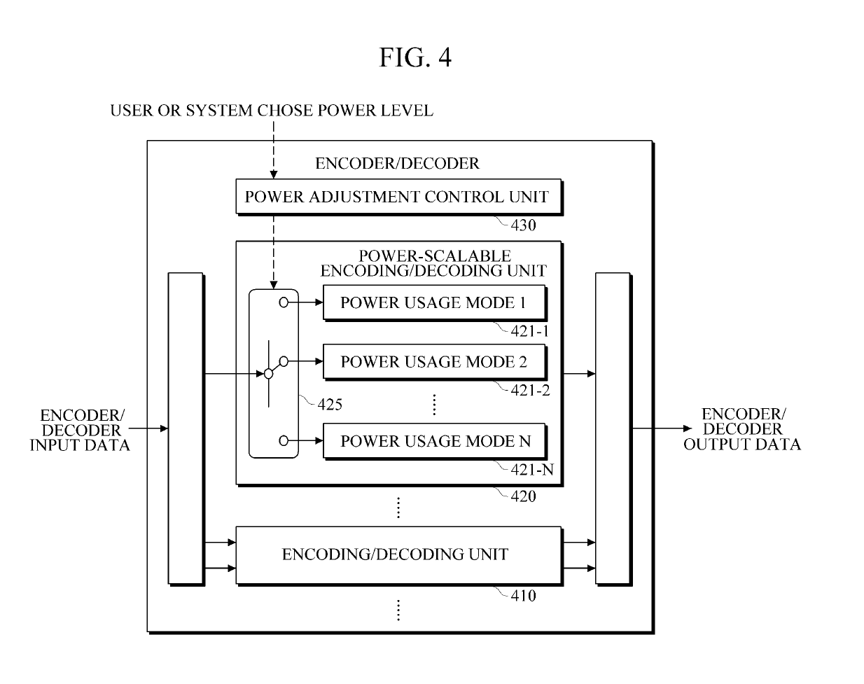

FIG. 4 is a diagram illustrating a power-scalable encoding/decoding apparatus according to another exemplary embodiment of the present invention.

Referring to FIG. 4, the power-scalable encoding/decoding apparatus includes an encoding/decoding unit 410, a power-scalable encoding/decoding unit 420, and a power adjustment control unit 430.

The encoding/decoding unit 410 may be configured to include one or more basic encoding/decoding units connected in series to one or more optional encoding/decoding units, as shown in FIG. 2. Alternatively, the encoding/decoding unit 410 may be configured to include one or more basic encoding/decoding units connected in parallel to one or more optional encoding/decoding units, as shown in FIG. 3. In addition, the encoding/decoding unit 410 may be configured by the combination of the configuration shown in FIG. 2 and the configuration shown in FIG. 3.

The power-scalable encoding/decoding unit 420 includes one or more power usage modes 421-1, 421-2, . . . , and 421-N, one of which is selected. To this end, the switch 425 is configured to switch to one of the power usage modes 421-1, 421-2, . . . , and 421-N.

Each of the power usage modes 421-1, 421-2, . . . , and 421-N determines and outputs a connection configuration of the encoding/decoding unit 410 to be used in accordance with the power level.

The power adjustment control unit 430 determines which power usage mode will be used according to a required amount of power consumption. An external system using an encoder/decoder or the user may manually or automatically choose a preferred power level. Then, the power adjustment control unit 430 outputs a switching control signal for the switch 425 according to the selection of the power usage modes 421-1, 421-2, . . . , and 421-N.

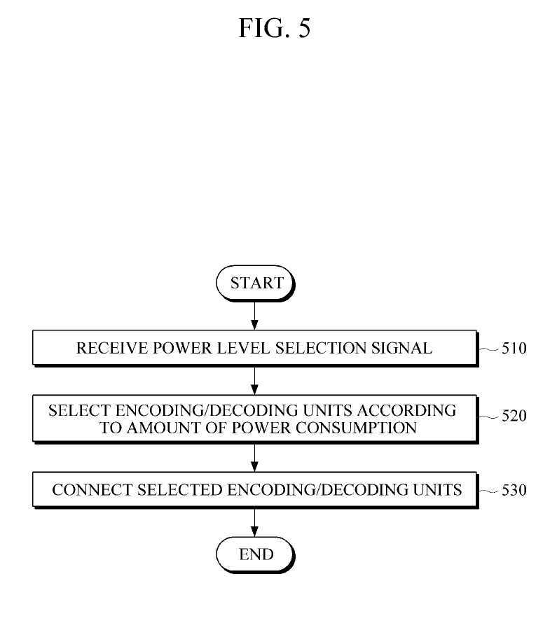

FIG. 5 is a flowchart illustrating a power-scalable encoding/decoding method according to an exemplary embodiment of the present invention.

Referring to FIG. 5, a power-scalable encoding/decoding apparatus receives a power level selection signal in 510. The power level may be automatically or manually chosen by a user or an external system using the encoding/decoding apparatus.

The power-scalable encoding/decoding apparatus selects one or more encoding/decoding unit according to power level in 520. The encoding/decoding units include one or more basic encoding/decoding units and one or more optional encoding/decoding units, and perform intermediate processes to output a signal received from an outside of the encoding/decoding apparatus. For example, the basic and optional encoding/decoding units may be functional blocks which perform operations involved in encoding/decoding, such as move/copy of memory, motion search, filtering, domain conversion/inversion, arithmetic encoding/decoding and the like. In addition, in the case of encoding/decoding a video having a multi-level frame rate or a multi-level resolution, the basic and optional encoding/decoding units may perform quality-related operations to control each level of the frame rate or resolution.

The one or more basic encoding/decoding units may perform essential procedures for completing encoding/decoding process, and they may be connected in series or parallel or in a combination of the two. The one or more optional encoding/decoding units are not necessarily required to complete the overall encoding/decoding process, and perform optional operations. The one or more optional encoding/decoding units may be connected in series or parallel or in a combination of the two. The one or more basic encoding/decoding units and the one or more optional encoding/decoding units may be connected in series or parallel or in a combination of the two.

In 520, the power-scalable encoding/decoding apparatus determines whether to use each of the one or more optional encoding/decoding units according to a required amount of power consumption. Alternatively, the power-scalable encoding/decoding apparatus may determine a power usage mode which decides how to connect the one or more basic encoding/decoding units to the one or more optional encoding decoding units.

In 530, the power-scalable encoding/decoding apparatus may switch to connect the selected encoding/decoding units to each other, or switch to the selected power usage mode.

According to the exemplary embodiments described above, the encoding/decoding apparatus and method may be applied to various techniques to reduce power consumption and to select a power level for use depending on a situation.

The current embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A power-scalable encoding/decoding apparatus comprising:
an encoding/decoding unit configured to perform one or more operations using a different amount of power; and
a power adjustment control unit configured to, in response to a power level selection signal being received from a user, control an amount of power consumption of the encoding/decoding unit.

2. The power-scalable encoding/decoding apparatus of claim 1, wherein the encoding/decoding unit comprises one or more basic encoding/decoding units, one or more optional encoding/decoding units and one or more switches configured to switch each of the one or more optional encoding/decoding unit in response to a control signal from the power adjustment control unit.

3. The power-scalable encoding/decoding apparatus of claim 2, wherein the one or more basic encoding/decoding units and the one or more optional encoding/decoding units are connected in series to each other.

4. The power-scalable encoding/decoding apparatus of claim 2, wherein the one or more basic encoding/decoding units and the one or more optional encoding/decoding units are connected in parallel to each other.

5. The power-scalable encoding/decoding apparatus of claim 2, wherein the one or more basic encoding/decoding units and the one or more optional encoding/decoding units are connected in series or parallel or in a combination of the two.

6. The power-scalable encoding/decoding apparatus of claim 3, further comprising:
a power-scalable encoding/decoding unit configured to determine a power usage mode which is a connection status between the one or more basic encoding/decoding units and the one or more optional encoding/decoding units, which are included in the encoding/decoding unit.

7. A power-scalable encoding/decoding method comprising:
receiving a power level selection signal from a user; and
controlling an amount of power consumption of an encoding/decoding unit which performs one or more operations using a different amount of power.

8. The power-scalable encoding/decoding method of claim 7, wherein the encoding/decoding unit performs one or more encoding/decoding processes and one or more optional encoding/decoding processes and performs the one or more optional encoding/decoding processes according to an amount of power consumption.
